(19) United States
(12) Patent Application Publication
(10) Pub. No.: US 2026/0142335 A1
(43) Pub. Date: May 21, 2026

(54) SEPARATOR FOR RECHARGEABLE BATTERY AND RECHARGEABLE BATTERY INCLUDING THE SAME

(71) Applicant: SAMSUNG SDI CO., LTD., Yongin-si (KR)

(72) Inventors: Chan Kyu LEE, Suwon-si (KR); Hyeon Seon CHOI, Suwon-si (KR); Jung Ran LEE, Suwon-si (KR); Jae Yeon LEE, Suwon-si (KR)

(73) Assignee: SAMSUNG SDI CO., LTD., Yongin-si (KR)

(21) Appl. No.: 19/389,654

(22) Filed: Nov. 14, 2025

(30) Foreign Application Priority Data
Nov. 16, 2024 (KR) 10-2024-0163678

(51) Int. Cl. H01M 50/46; H01M 50/42; H01M 50/431; H01M 50/44; H01M 50/443; H01M 50/446; H01M 50/457; H01M 50/491

(52) U.S. Cl. CPC H01M 50/461; H01M 50/42; H01M 50/431; H01M 50/44; H01M 50/443; H01M 50/446; H01M 50/457; H01M 50/491

(57) ABSTRACT

The present disclosure relates to a separator for a rechargeable battery, and a rechargeable battery including the separator. The separator for a rechargeable battery includes a porous substrate and a coating layer located on at least one surface of the porous substrate. The coating layer includes a crosslinked product of a binder and a crosslinking agent, and a filler. The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof. The crosslinking agent includes an aziridine-based crosslinking agent, the filler includes a mixture of a first filler and a second filler, and the first filler is an inorganic filler and the second filler is a fibrous filler.

### CROSS-REFERENCE TO RELATED APPLICATION

The present application claims priority to Korean Patent Application No. 10-2024-0163678, filed on Nov. 16, 2024 in the Korean Intellectual Property Office, the entire disclosure of which is incorporated herein by reference.

### BACKGROUND

### 1. Field of the Disclosure

The present disclosure relates to a separator for a rechargeable battery, and a rechargeable battery including the separator.

### 2. Discussion of Related Art

With increasing presence of electronic devices that use batteries such as, e.g., mobile phones, notebook computers, electric vehicles, and the like, the demand for rechargeable batteries having high energy density and high capacity has been increasing. Accordingly, improving the performance of rechargeable lithium batteries may be advantageous.

A rechargeable lithium battery includes positive and negative electrodes that include active materials capable of intercalating and deintercalating lithium ions, and an electrolyte, and produces electrical energy through oxidation and reduction reactions when lithium ions are intercalated and deintercalated into/from the positive and negative electrodes.

A rechargeable lithium battery may include a separator between the positive and negative electrodes. The separator is impregnated with the electrolyte and is joined to the positive electrode or negative electrode.

### SUMMARY

One example embodiment includes a separator for a rechargeable battery which exhibits a low thermal shrinkage rate, high rate characteristics during charging and discharging, low membrane resistance, and high adhesion to an electrode plate.

Another example embodiment includes a rechargeable battery including the separator for a rechargeable battery.

One example embodiment includes a separator for a rechargeable battery.

The separator for a rechargeable battery includes a porous substrate, a first coating layer and a first adhesive layer located, e.g., sequentially located, on a first surface of the porous substrate; and a second coating layer and a second adhesive layer located, e.g., sequentially located on a second surface of the porous substrate, wherein the first coating layer and the second coating layer each include a crosslinked product of a binder and a crosslinking agent, and a filler, the binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof, the crosslinking agent includes an aziridine-based crosslinking agent, the filler includes a mixture of a first filler and a second filler, wherein the first filler is an inorganic filler and the second filler is a fibrous filler, the first adhesive layer includes a (meth)acrylic adhesive binder, and the second adhesive layer includes a fluorine-based adhesive binder having a carbonyl group (C═O).

Another example embodiment provides a rechargeable battery.

The rechargeable battery includes a positive electrode, a negative electrode, and the above-described separator for a rechargeable battery located between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view showing a separator for a rechargeable lithium battery according to one example embodiment; and

FIGS. 2 to 5 are cross-sectional views schematically showing rechargeable lithium batteries according to example embodiments of the present disclosure.

### DETAILED DESCRIPTION

Hereinafter, example embodiments of the present disclosure are described in detail. However, the embodiments are provided as examples, the present disclosure is not limited thereto, and the present disclosure is only defined by the scope of the claims to be described later.

Unless otherwise specified herein, when a part such as a layer, film, region, plate, etc. is described as being “on” another part, it includes not only the case where the part is “directly on” the other part but also the case where there is still another part therebetween.

Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Here, the term “particle size D50” refers to the average particle size, which means the size of particles with a cumulative volume of 50% by volume in the particle size distribution. The particle size distribution may be measured by methods known to those skilled in the art. For example, the particle size distribution may be measured using a particle size analyzer, a transmission electron micrograph, or a scanning electron micrograph. In another method, an D50 value may be obtained by measuring the particle size using a measuring device using dynamic light scattering, performing data analysis to count the number of particles for each particle size range, and then calculating the particle size therefrom. Alternatively, D50 may be measured using a laser diffraction method. For example, when measuring by laser diffraction, after the particles to be measured are dispersed in a dispersion medium, the particles may be introduced into a commercially available laser diffraction particle size measuring device (e.g., Microtrac MT 3000) and irradiated with ultrasonic waves of about 28 kHz at an output of 60 W, and the D50 based on 50% of the particle size distribution in the measurement device may be calculated.

When the particle is spherical, the size may mean a diameter.

In this specification, “(meth)acrylic” means acrylic and/or methacrylic.

Unless otherwise defined herein, “substitution” means that hydrogen in a compound is replaced by a substituent such as or including at least one of the following: a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br or I), a hydroxyl group (—OH), a nitro group (—NO₂), a cyano group (—CN), an amino group (—NRR′) (wherein, R and R′ are each independently hydrogen or a C1 to C6 alkyl group), a sulfobetaine group (—RR′N⁺(CH₂)ₙSO₃⁻, n is a natural number from 1 to 10), a carboxybetaine group (—RR′N⁺(CH₂)ₙCOO⁻, n is a natural number from 1 to 10) (wherein, R and R′ are each independently a C1 to C20 alkyl group), an azido group (—N₃), an amidino group (—C(═NH)NH₂), a hydrazino group (—NHNH₂), a hydrazono group (═N(NH₂), a carbamoyl group (—C(O)NH₂), a thiol group (—SH), an acyl group (—C(═O)R, where R is hydrogen, a C1 to C6 alkyl group, a C1 to C6 alkoxy group, or a C6 to C12 aryl group), a carboxyl group (—COOH) or a salt thereof (—C(═O)OM, where M is an organic or inorganic cation), a sulfonic acid group (—SO₃H) or a salt thereof (—SO₃M, where M is an organic or inorganic cation), a phosphate group (—PO₃H₂) or a salt thereof (—PO₃MH or —PO₃M₂, where M is an organic or inorganic cation), and combinations thereof.

Hereinafter, a C1 to C3 alkyl group means a methyl group, an ethyl group, or a propyl group. A C1 to C10 alkylene group may be, for example, a C1 to C6 alkylene group, a C1 to C5 alkylene group, or a C1 to C3 alkylene group, such as, a methylene group, an ethylene group, or a propylene group. A C3 to C20 cycloalkylene group may be, for example, a C3 to C10 cycloalkylene group or a C5 to C10 cycloalkylene group, such as a cyclohexylene group. A C6 to C20 arylene group may be, for example, a C6 to C10 arylene group, such as, a phenylene group. A C3 to C20 heterocyclic group may be, for example, a C3 to C10 heterocyclic group, such as a pyridine group.

Hereinafter, “hetero” means including one or more heteroatoms such as or including at least one of N, O, S, Si, and P.

In chemical formulas, the * symbol indicates a moiety that is connected to the same or different atoms, groups, or structural units. Unless otherwise specifically stated in the chemical formulas described herein, it may be assumed that hydrogen is bonded in the structure of the chemical formula.

Hereinafter, “alkali metal” refers to an element belonging to Group 1 of the periodic table, such as lithium, sodium, potassium, rubidium, cesium, or francium and may be present in a cationic or neutral state.

When describing a numerical range in this specification, ‘X to Y’ means ‘X or more and Y or less (X≤ and ≤Y).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

Hereinafter, a separator for a rechargeable battery and a rechargeable battery including the separator of the present disclosure are described in detail.

Hereinafter, only rechargeable lithium batteries are described. However, the present disclosure may also be applied to rechargeable batteries of different metal ions in addition to rechargeable lithium batteries.

According to one example embodiment, the separator for a rechargeable lithium battery includes a porous substrate, a first coating layer and a first adhesive layer located, e.g., sequentially located on a first surface of the porous substrate, and a second coating layer and a second adhesive layer located, e.g., sequentially located on a second surface of the porous substrate. The first coating layer and the second coating layer each include a crosslinked product of a binder and a crosslinking agent, and a filler. The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof. The crosslinking agent includes an aziridine-based crosslinking agent. The filler includes a mixture of a first filler and a second filler, wherein the first filler is an inorganic filler and the second filler is a fibrous filler. The first adhesive layer includes a (meth)acrylic adhesive binder, and the second adhesive layer includes a fluorine-based adhesive binder having a carbonyl group (C═O).

According to one example embodiment, the first adhesive layer may be bonded to a negative electrode of the battery, and the second adhesive layer may be bonded to a positive electrode of the battery.

According to one example embodiment, the crosslinked product may be or include a thermally crosslinked product.

According to one example embodiment, the first coating layer and the second coating layer each may be formed from a composition for a coating layer including the (meth)acrylic binder, the aziridine-based crosslinking agent, and the filler.

The separator can provide a low thermal shrinkage rate and high adhesion to an electrode plate.

In one example embodiment, the separator may have a dry thermal shrinkage rate of about 5% or less in the machine direction (MD) and the transverse direction (TD), a wet thermal shrinkage rate of about 10% or less in the machine direction (MD) and the transverse direction (TD), and a membrane resistance of about 0.7Ω or less. Here, the MD and TD are substantially the same direction as the MD and TD of the porous substrate, respectively.

In one example embodiment, the separator may have an adhesion to a positive electrode of about 1.1 gf/mm or more and an adhesion to a negative electrode of about 0.7 gf/mm or more.

In one example embodiment, the separator may have a surface roughness of about 0.6 m or less.

Here, the “surface roughness” is obtained by measuring a separator surface using an Olympus microscope, calculating the arithmetic mean roughness (Ra) value through the arithmetic mean of the absolute vertical coordinates within the sampling length, and calculating the Ra values of each of the first and second coating layers of the separator to calculate the average value.

The first coating layer and the second coating layer, which only include the first filler or the second filler, may present a challenge in that the wet thermal shrinkage rate increases.

The first coating layer and the second coating layer, which include only the filler, that is, a mixture of the first filler and the second filler, may present a challenge in that the dry thermal shrinkage rate increases. A separator having the first coating layer and the second coating layer including the filler and a crosslinked product of the (meth)acrylic binder and the aziridine-based crosslinking agent can provide an effect of increasing the adhesion to the electrode plates while satisfying both dry thermal shrinkage and wet thermal shrinkage A separator having a coating layer formed with a composition for a coating layer, which includes the (meth)acrylic binder but does not include an aziridine-based crosslinking agent as a crosslinking agent or contains a crosslinking agent other than an aziridine-based crosslinking agent, may exhibit a lower battery reliability due to an increase in the above-described wet thermal shrinkage rate. According to one example embodiment, the aziridine-based crosslinking agent may be included in an amount of about 95 wt % or more, for example, a range of about 98 wt % to 100 wt %, or 100 wt %, of the total crosslinking agent in the composition for a coating layer.

A separator having a coating layer formed with a composition for a coating layer, which includes the aziridine-based crosslinking agent but does not include the (meth)acrylic binder or contains a binder other than the (meth)acrylic binder exhibits a high thermal shrinkage rate, high membrane resistance, and high air permeability, which may present challenges with the capacity, lifespan, and safety of the battery. According to one example embodiment, the (meth)acrylic binder may be included in an amount of about 95 wt % or more, for example, a range of about 98 wt % to about 100 wt %, or 100 wt %, of the total binder in the composition.

The filler includes a mixture of the first filler and the second filler. A separator formed with a composition for a coating layer including only the first filler may have poor rate characteristics during charging and discharging of a battery. A separator formed with a composition for a coating layer including only the second filler may have poor battery reliability due to an increased wet thermal shrinkage rate. According to one example embodiment, the mixture of the first filler and the second filler may be included in an amount of about 95 wt % or more, for example, in a range of about 98 wt % to about 100 wt %, or 100 wt %, of the total filler in the composition.

The first adhesive layer includes a (meth)acrylic adhesive binder, and the second adhesive layer includes a fluorine-based adhesive binder having a carbonyl group. The separator having the first adhesive layer and the second adhesive layer can provide high adhesion to the positive electrode and the negative electrode, and can be advantageous in providing a remarkably low wet shrinkage rate.

### First Coating Layer

The first coating layer may be or include a heat-resistant layer.

The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof.

According to one example embodiment, the (meth)acrylic binder may be or include a non-adhesive binder.

According to one example embodiment, the (meth)acrylic binder may be or include a salt-based binder, for example, an alkali metal salt-based binder. Here, the alkali metal may be or include at least one of lithium, sodium, potassium, rubidium, or cesium. In this case, it may be possible to lower the membrane resistance of the separator.

The (meth)acrylic binder may fix the filler onto the porous substrate, enable the first coating layer to adhere to the porous substrate and the electrode, and contribute to improving the heat resistance, air permeability, and oxidation resistance of the separator. In addition, the (meth)acrylic binder can facilitate the movement of lithium ions, thereby lowering membrane resistance and improving ion conductivity, increase the adhesion of the first coating layer to the porous substrate and the electrode, and increase the dispersibility of the filler within the first coating layer. In addition, the (meth)acrylic binder in the first coating layer including the filler described below can provide a separator having low membrane resistance, a low dry thermal shrinkage rate, and a low wet thermal shrinkage rate.

The sum of the contents of the first structural unit, the second structural unit, and the third structural unit may be about 95 mol % or more, for example, a range of about 95 mol % to about 100 mol %, for example, 100 mol %, based on 100 mol % of the (meth)acrylic binder. In the above range, the above-described separator effect may be readily implemented.

The first structural unit is derived from (meth)acrylic acid, (meth)acrylate, or a salt thereof, and may fix the filler onto the porous substrate while providing adhesion so that the first coating layer may be attached to the porous substrate and the electrode, and may contribute to improving the heat resistance and air permeability of the separator. In addition, the first structural unit may improve the dispersibility of the coating layer composition by having a carboxyl functional group (—C(═O)O—) within the structural unit.

The first structural unit may be represented by any one of the following Chemical Formulas 1 to 3:

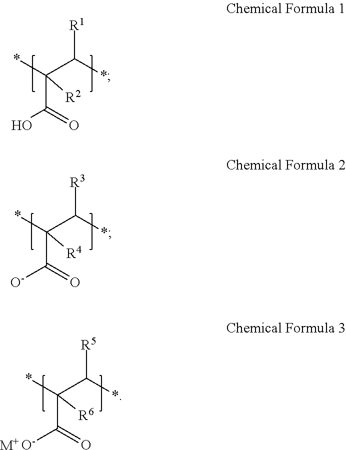

The first structural unit may be included in an amount in a range of about 20 mol % to about 75 mol %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74.75 mol %, 25 mol % to 70 mol %, 30 mol % to 65 mol %, 30 mol % to 60 mol %, or 40 mol % to 65 mol %, based on 100 mol % of the binder for a rechargeable lithium battery. When the first structural unit is included in the above range, the separator may exhibit low membrane resistance, desired or improved adhesion to the porous substrate and the electrode, and desired or improved heat resistance, air permeability, and oxidation resistance.

According to one example embodiment, the first structural unit may include the structural unit represented by Chemical Formula 2 and the structural unit represented by Chemical Formula 3, in which case the structural unit represented by Chemical Formula 2 and the structural unit represented by Chemical Formula 3 may be included in a molar ratio in a range of about 10:1 to about 1:2, 10:1 to 1:1, or 5:1 to 1:1.

According to another example embodiment, the first structural unit may include only the structural unit represented by Chemical Formula 2 or Chemical Formula 3.

The second structural unit is derived from hydroxyalkyl (meth)acrylate and may fix the filler onto the porous substrate while providing adhesion so that the first coating layer may be attached to the porous substrate and the electrode. In addition, the second structural unit may improve the dispersibility of the first coating layer composition by having a carboxyl functional group (—C(═O)O—) within the structural unit.

The second structural unit may be represented by the following Chemical Formula 4:

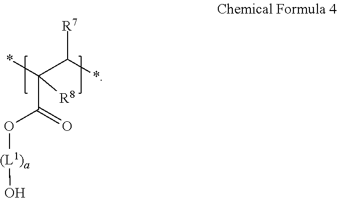

The second structural unit may be included in an amount in a range of about 1 mol % to about 20 mol %, for example, 1, 2, 3, 4, 5, 6, 7, 8, 9, 10, 11, 12, 13, 14, 15, 16, 17, 18, 19.20 mol %, 2 mol % to 15 mol %, 5 mol % to 15 mol %, or 5 mol % to 10 mol %, based on 100 mol % of the binder for a rechargeable lithium battery. In the above range, it may be possible to increase the adhesiveness of the coating layer to the porous substrate and the electrode.

The second structural unit may be, for example, a structural unit derived from hydroxyalkyl (meth)acrylate. Here, the alkyl may be or include a C1 to C20 alkyl, a C1 to C10 alkyl, or a C1 to C6 alkyl.

The hydroxyalkyl (meth)acrylate may include, for example, at least one or more of hydroxymethyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, and 6-hydroxyhexyl (meth)acrylate.

The third structural unit derived from the (meth)acrylamidosulfonic acid or a salt thereof may lower the membrane resistance of the separator by increasing the possibility of lithium ion movement in the presence of the first structural unit and the second structural unit.

The third structural unit may enhance the heat resistance of the separator by including a bulky functional group derived from (meth)acrylamidosulfonic acid or a salt thereof, thereby increasing the glass transition temperature. When the third structural unit includes a functional group derived from a salt of (meth)acrylamidosulfonic acid, the metal (M) can move through the third structural unit by a sulfonic acid functional group substituted with the metal (M), thereby exhibiting an effect of lowering membrane resistance.

The third structural unit may be represented by at least one of Chemical Formula 5, Chemical Formula 6, Chemical Formula 7, or a combination thereof:

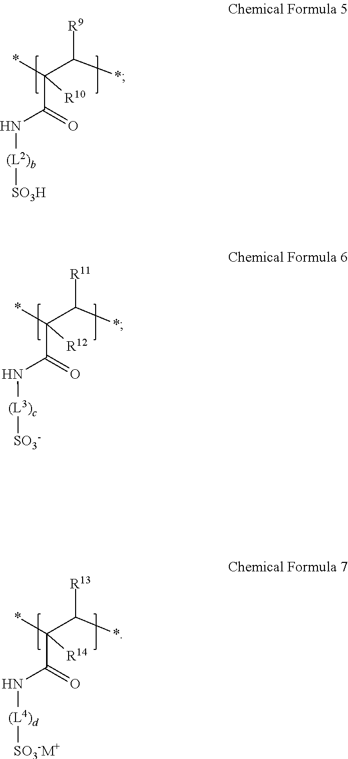

The third structural unit may include only one or two or more types of the structural unit represented by Chemical Formula 5, the structural unit represented by Chemical Formula 6, and the structural unit represented by Chemical Formula 7. For example, the third structural unit may include the structural unit represented by Chemical Formula 6, and as another example, the third structural unit may include the structural unit represented by Chemical Formula 6 and the structural unit represented by Chemical Formula 7.

The third structural unit may be or include, for example, a structural unit derived from (meth)acrylamidoalkane sulfonic acid or a salt thereof. Here, the alkane may be or include a C1 to C20 alkane, a C1 to C10 alkane, or a C1 to C6 alkane, and the alkyl may be or include a C1 to C20 alkyl, a C1 to C10 alkyl, or a C1 to C6 alkyl. The salt means a salt composed of or including the above-described sulfonic acid and a desired ion. The ion may be, for example, an alkali metal ion, in which case the salt may be or include a sulfonic acid alkali metal salt.

For example, the (meth)acrylamidoalkane sulfonic acid may be 2-(meth)acrylamido-2-methylpropane sulfonic acid.

The third structural unit may be included in an amount in a range of about 20 mol % to about 75 mol %, for example, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74.75 mol %, 25 mol % to 70 mol %, 20 mol % to 65 mol %, 30 mol % to 65 mol %, or 30 mol % to 60 mol % in the (meth)acrylic binder. When the third structural unit is included in the above range, the (meth)acrylic binder and a separator including the (meth)acrylic binder may exhibit significantly low membrane resistance.

The description of Chemical Formulas 1 to 7 is as follows.

R¹ to R¹⁴ may each independently be or include hydrogen or a C1 to C10 alkyl group. For example, R¹ to R⁷ and R⁹ to R¹⁴ may each be or include hydrogen or a methyl group; and R⁸ may be or include a methyl group.

L¹ to L⁴ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L¹ may be or include a methylene group or an ethylene group, and L² to L⁴ may each independently be or include *—C(CH₃)₂—CH₂—*.

a, b, c, and d may each independently be an integer in a range from 0 to 2. For example, a, b, c, and d may all be equal to 1.

M may be or include an alkali metal, and the alkali metal may be or include at least one of lithium, sodium, potassium, rubidium, or cesium. For example, M may be or include lithium or sodium.

A representative example of the (meth)acrylic binder according to one example embodiment is as shown in the following Chemical Formula 8:

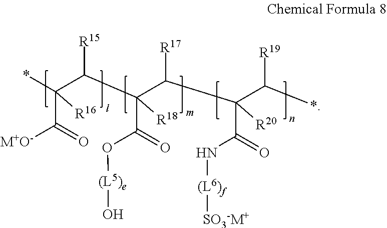

The description for the above Chemical Formula 8 is as follows.

R¹⁵ to R²⁰ may each independently be or include hydrogen or a C1 to C10 alkyl group. For example, R¹⁵ to R¹⁷, R¹⁹ and R²⁰ may each be or include hydrogen or a methyl group; and R¹⁸ may be or include a methyl group.

L⁵ and L⁶ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. For example, L⁵ may be or include a methylene group or an ethylene group, and L⁶ may be or include *—C(CH₃)₂—CH₂—*.

M may be or include an alkali metal, and the alkali metal may be or include at least one of lithium, sodium, potassium, rubidium, or cesium. For example, M may be or include lithium or sodium.

e and f may each be independently an integer in a range from 0 to 2. For example, e and f may all be equal to 1.

l, m, and n may be molar ratios of each unit, and 1+m+n=1. For example, 0.20≤1≤0.75, 0.01≤m≤0.2, and 0.2≤n≤0.75, for example, 0.25≤1≤0.70, 0.01≤m≤0.15, and 0.25≤n≤0.75, or 0.3≤1≤0.65, 0.05≤m≤0.15, and 0.3≤n≤0.65.

The (meth)acrylic binder may include an alkali metal. The alkali metal may be present in the form of a cation, for example, lithium, sodium, potassium, rubidium, or cesium. For example, the alkali metal may be present in the form of a salt combined with the (meth)acrylic binder. The alkali metal may assist the synthesis of the (meth)acrylic binder in an aqueous solvent, improve the adhesion of the coating layer, and improve the heat resistance, air permeability, and oxidation resistance of the separator.

The alkali metal may be included in an amount in a range of about 1 wt % to about 40 wt %, for example, 1 wt % to 30 wt %, 1 wt % to 20 wt %, or 10 wt % to 20 wt % based on the total content of the alkali metal and the (meth)acrylic binder. For example, the (meth)acrylic binder and the alkali metal may be included in a weight ratio in a range of about 99:1 to about 60:40, a weight ratio of 99:1 to 70:30, for example, a weight ratio of 99:1 to 80:20, for example, a weight ratio of 90:10 to 80:20.

The alkali metal may be included in an amount in a range of about 0.1 mol % to about 1.0 mol % based on the total content of the alkali metal and the (meth)acrylic binder. When the alkali metal is included within the above range, the coating layer may have desired or improved adhesion, and a separator including the coating layer may exhibit desired or improved heat resistance, air permeability, and oxidation resistance.

The (meth)acrylic heat-resistant binder may have various forms, such as an alternating polymer in which the structural units are alternately distributed, a random polymer in which the structural units are randomly distributed, or a graft polymer in which some of the structural units are grafted.

A weight average molecular weight of the (meth)acrylic binder may be in a range of about 100,000 g/mol to 1,000,000 g/mol, 100,000 g/mol to 500,000 g/mol, 100,000 g/mol to 150,000 g/mol, 130,000 g/mol to 200,000 g/mol, or 300,000 g/mol to 900,000 g/mol. When the weight average molecular weight of the (meth)acrylic binder satisfies the above range, the (meth)acrylic binder may exhibit desired or improved adhesion and low resistance. The weight average molecular weight may be a polystyrene-converted average molecular weight measured using gel permeation chromatography.

The (meth)acrylic binder may be prepared by a solution polymerization method.

According to one example embodiment, the (meth)acrylic binder may be included in a film form in the coating layer of the separator.

The crosslinking agent includes an aziridine-based crosslinking agent.

The aziridine-based crosslinking agent may crosslink the (meth)acrylic binder to facilitate the separator in reaching the above-described thermal shrinkage rate range in the electrolyte. In addition, the aziridine-based crosslinking agent may crosslink the (meth)acrylic binder to significantly lower the membrane resistance of the separator. In addition, the aziridine-based crosslinking agent may crosslink the (meth)acrylic binder to increase the adhesion to the electrode.

The aziridine-based crosslinking agent may be or include a bifunctional or higher aziridine-based crosslinking agent. Here, “bifunctional or higher” means that there are two or more aziridine groups in the molecule. According to one example embodiment, the aziridine-based crosslinking agent may be or include a bifunctional or trifunctional aziridine-based crosslinking agent.

For example, the aziridine-based crosslinking agent may include at least one or more of N,N′-toluene-2,4-bis(1-aziridine carboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

The crosslinking agent, for example, the aziridine-based crosslinking agent, may be included in a desired amount with respect to the binder, for example, the (meth)acrylic binder. According to one example embodiment, the crosslinking agent may be included in an amount in a range of about 5 parts by weight to about 50 parts by weight, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 parts by weight, 5 parts by weight to 30 parts by weight, 5 parts by weight to 25 parts by weight, or 5 parts by weight to 20 parts by weight, based on 100 parts by weight of the (meth)acrylic binder. In the above range, the thermal shrinkage rate and membrane resistance of the separator in the electrolyte may be significantly lowered.

The filler includes a mixture of a first filler and a second filler, wherein the first filler is or includes an inorganic filler and the second filler is or includes a fibrous filler.

In one example embodiment, the inorganic filler may be or include a non-fibrous filler rather than a fibrous filler.

The first filler may be spherical, platy, cubic, or amorphous. For example, the first filler may be cubic, and in the case of the cubic type, the above-described thermal shrinkage rate may be significantly lowered.

The first filler may have an average particle size D50 in a range of about 100 nm to about 200 nm, for example, 100, 105, 110, 115, 120, 125, 130, 135, 140, 145, 150, 155, 160, 165, 170, 175, 180, 185, 190, 195, 200 nm, 120 nm to 180 nm, or 150 nm. In the above range, it may be possible to reach the above-described wet thermal shrinkage rate when the first filler is combined with the second filler described below.

The first filler may be or include a ceramic material as an inorganic filler. The inorganic filler may include at least one of a metal oxide, a metalloid oxide, a metal fluoride, a metal hydroxide, or a combination thereof. The inorganic filler may include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. For example, the filler may be boehmite.

The second filler is or includes a fibrous filler. The fibrous filler has a fibrous form and may fill the space between the first fillers, thereby reducing shrinkage in the electrolyte, and may have the effect of reducing the surface roughness of each of the first coating layer and the second coating layer, thereby increasing the adhesion to the electrode plate by the particle-type adhesive binder.

In one example embodiment, the fibrous filler may have an aspect ratio in a range of about 5 or more, for example, in a range about 5 to about 500. Here, the aspect ratio refers to a ratio of the length to the size of the fibrous filler. The size of the fibrous filler may be in a range of about 10 nm to about 200 nm, for example 10, 20, 30, 40, 50, 60, 70, 80, 90, 100, 110, 120, 130, 140, 150, 160, 170, 180, 190, 200 nm, 10 nm to 100 nm, and the length may be about 100 nm or more, for example in a range of about 100 nm to 1000 nm. In the above range, the aspect ratio may be readily achieved.

The fibrous filler may include at least one of boehmite, carbon nanotubes, silver nanowires, boron carbide nanowires, nanocellulose, copper hydroxide nanowires, silicon monoxide nanowires, hydroxyapatite nanowires, Al₂O₃, TiO₂, SiO₂, or a combination thereof.

The first filler and the second filler may be included in a weight ratio in a range of about 50:50 to about 95:5 based on 100 parts by weight of the mixture. In the above range, the weight ratio may be advantageous for lowering the dry thermal shrinkage rate and the wet thermal shrinkage rate. For example, the weight ratio may be 50:50, 55:45, 60:40, 65:35, 70:30, 75:25, 80:20, 85:15, 90:10, 95:5, 55:45 to 95:5, 60:40 to 90:10, or 60:40 to 50:50, and in the above range, rate characteristics may be further improved.

The filler, that is, the mixture, and the (meth)acrylic binder, may be included in a (meth)acrylic binder:mixture mass ratio in a range of about 1:10 to about 1:50, for example, 1:10, 1:15, 1:20, 1:25, 1:30, 1:35, 1:40, 1:45, 1:50, 1:10 to 1:40 or 1:20 to 1:30. In the above range, there may be an effect of improving heat resistance within the electrolyte.

The filler, e.g., the mixture, may be included in an amount in a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, for example, 95 wt % to 99 wt % of the total amount of the coating layer. When the filler is included within the above range, desired or improved heat resistance, durability, oxidation resistance and stability may be exhibited.

The first coating layer may have a thickness in a range of about 0.01 μm to about 20 μm, and within the above range, the thickness may be 0.01 μm to 7 μm, 0.1 μm to 5 μm, or 0.1 μm to 3 μm. For example, the first coating layer may have a thickness of 0.1 μm to 2 μm.

The ratio of the thickness of the first coating layer to the thickness of the porous substrate may range from about 0.01 to about 0.7, for example, from 0.01 to 0.5, from 0.01 to 0.4, or from 0.01 to 0.3. In the above range, the separator can exhibit desired or improved air permeability, heat resistance, and adhesiveness.

### First Adhesive Layer

The first adhesive layer includes a (meth)acrylic adhesive binder. The (meth)acrylic adhesive binder may increase the adhesion to a negative electrode. The adhesive binder may be particle-shaped and crosslinked.

The (meth)acrylic adhesive binder may include a (meth)acrylate-based polymer or copolymer. According to one example embodiment, the adhesive binder may be or include a crosslinked (meth)acrylate-based polymer or copolymer. For example, the adhesive binder may include a crosslinked polymethyl methacrylate (PMMA)-based polymer.

In order to prepare the crosslinked (meth)acrylic polymer, a crosslinking agent may be further added during a polymerization step. The (meth)acrylic adhesive binder may have a glass transition temperature in a range of about 50° C. to about 110° C., for example, 50° C. to 70° C. In the above range, not only is electrode adhesion desired or improved, but ionic conductivity is also desired. The glass transition temperature may be measured using differential scanning calorimetry (DSC). For example, after placing 2 mg of a polymer in a pressure-resistant pan for DSC measurement, a temperature range was set to 25° C. to 200° C., a temperature increase rate was set to 10° C./min, and the glass transition temperature was obtained in a controlled atmosphere.

The (meth)acrylic adhesive binder may be included in an amount of about 95 wt % or more, for example, in a range of about 95 wt % to 100 wt %, or 100 wt % in the first adhesive layer.

The first adhesive layer may have a thickness in a range of about 0.01 μm to about 20 μm, and within the above range, may have a thickness of 0.01 μm to 7 μm, or 0.1 μm to 5 μm, or 0.1 μm to 3 μm. For example, the first adhesive layer may have a thickness of 0.1 μm to 2 μm.

### Second Coating Layer

The second coating layer may be or include a heat-resistant layer.

The binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof.

Details regarding the (meth)acrylic binder are omitted because such details are substantially the same as the (meth)acrylic binder in the first coating layer. The detailed composition of the (meth)acrylic binder in the first coating layer may be substantially the same as the (meth)acrylic binder in the second coating layer.

The crosslinking agent includes an aziridine-based crosslinking agent, and the filler includes a mixture of a first filler and a second filler. The detailed composition of each of the aziridine-based crosslinking agent, the first filler, and the second filler may be substantially the same as the composition described in the first coating layer.

### Second Adhesive Layer

The second adhesive layer includes a fluorine-based adhesive binder having a carbonyl group (C═O). The fluorine-based adhesive binder may be advantageous in providing high adhesion to a positive electrode.

The adhesive binder includes a mixture of a fluorine-based homopolymer, and an interpenetrating polymer network (IPN) binder (hereinafter also referred to as an IPN binder) of a fluorine-based crosslinked polymer and an acrylate-based crosslinked polymer. The mixture may be included in the second adhesive layer to advantageously increase the adhesion to the positive electrode.

In one example embodiment, the adhesive binder may be an aqueous binder.

According to one example embodiment, the mixture may be included in an amount of about 95 wt % or more, for example, in a range of about 95 wt % to about 100 wt % or 100 wt %, of the adhesive binder.

The fluorine-based homopolymer may include a polyvinylidene fluoride-based homopolymer.

The fluorine-based homopolymer is a material having a high melting point (Tm) in a range of about 100° C. to about 200° C., and the particle shape thereof is maintained even after a thermal compression process, thereby contributing to securing air permeability of the separator after thermal compression. The fluorine-based homopolymer may have a melting point of about 100° C. or higher, 120° C. or higher, or 130° C. or higher, and about 200° C. or lower, 180° C. or lower, or 170° C. or lower.

The fluorine-based homopolymer may be located within the network structure of the IPN binder to enhance air permeability. In addition, the fluorine-based homopolymer can provide desired or improved adhesion.

The fluorine-based homopolymer may have a particle size D50 in a range of about 50 nm to about 1000 nm. In the above range, desired or improved air permeability may be provided to the separator for a rechargeable lithium battery. For example, the particle size D50 may be about 50 nm or more, 100 nm or more, 150 nm or more, 200 nm or more and about 1000 nm or less, 800 nm or less, 600 nm or less, 400 nm or less, or 300 nm or less.

The fluorine-based homopolymer may have a weight average molecular weight in a range of about 100,000 g/mol or more, 200,000 g/mol or more, 300,000 g/mol or more, or about 1,500,000 g/mol or less.

According to one example embodiment, the fluorine-based homopolymer may have a carbonyl (C═O) functional group. The carbonyl (C═O) functional group may add an adhesive function when the homopolymer is applied to an adhesive layer. A method for introducing a carbonyl functional group into the homopolymer may be a conventional method known to those skilled in the art.

The IPN binder may be or include a particle-type binder in which the fluorine-based crosslinked polymer and the acrylate-based crosslinked polymer form an interpenetrating polymer network. The two crosslinked polymers forming the interpenetrating polymer network can impart desired or improved adhesion to the separator for a rechargeable lithium battery of one example embodiment.

For example, the acrylate-based crosslinked polymer and the fluorine-based crosslinked polymer each have a network structure, and may be entangled in a network form.

The acrylate-based crosslinked polymer may be or include a crosslinked polymer such as or including at least one of polymethyl methacrylate, polymethacrylate, polyethyl acrylate, polyacrylate, polybutylacrylate, and the like.

The fluorine-based crosslinked polymer may be or include a crosslinked polymer such as or including at least one of a homopolymer including only a vinylidene fluoride monomer-derived structural unit, a copolymer including a vinylidene fluoride-derived structural unit and a structural unit derived from another monomer, and the like.

The copolymer may include, but is not limited to, a vinylidene fluoride-derived structural unit and one or more structural units derived from chlorotrifluoroethylene, trifluoroethylene, hexafluoropropylene, ethylene tetrafluoride and ethylene monomers. For example, the copolymer may be or include at least one of a polyvinylidene fluoride-hexafluoropropylene (PVdF-HFP) copolymer including a vinylidene fluoride monomer-derived structural unit and a hexafluoropropylene monomer-derived structural unit.

According to one example embodiment, the fluorine-based adhesive binder may be an aqueous particle-type adhesive binder.

In one example embodiment, the copolymer adhesive binder includes about 75 mol % to about 90 mol % of repeating units derived from vinylidene fluoride and about 10 mol % to about 25 mol % of repeating units derived from hexafluoropropylene, based on 100 mol of the total moles of vinylidene fluoride and hexafluoropropylene, and may further include repeating units derived from a monomer having a carbonyl group.

A weight ratio of the acrylate-based crosslinked polymer and the fluorine-based crosslinked polymer may be in a range of about 8:2 to about 1:9. Within the above range, desired or improved adhesion may be maintained even after thermal compression of the separator for a rechargeable lithium battery according to an example embodiment. For example, the weight ratio may range from 8:2 to 1:9, from 7:3 to 2:8, from 6:4 to 2:8, or from 5:5 to 3:7.

A weight average molecular weight of the IPN binder may be about 100,000 g/mol or more. In the above range, desired or improved adhesion may be maintained even after thermal compression of the separator for a rechargeable lithium battery. For example, the weight average molecular weight of the IPN binder may be about 200,000 g/mol or more or about 300,000 g/mol or more, and about 1,500,000 g/mol or less.

In the adhesive layer, the fluorine-based homopolymer and the IPN binder of the fluorine-based crosslinked polymer and the acrylate-based crosslinked polymer may be included in a weight ratio in a range of about 95:5 to about 15:85 based on a total of 100 wt %. In the above range, there may be a synergistic effect in providing desired or improved adhesion and enhancing air permeability. For example, the weight ratio may be 95:5 to 15:85, 85:15 to 15:85, or 80:20 to 20:80.

A loading amount of the mixture may be in a range of about 0.1 g/m² to about 1.0 g/m² per one side of the substrate. In the above range, desired or improved adhesion, thermal stability, and structural stability may be enhanced.

The adhesive binder, for example, the mixture may be included in an amount in a range of about 1 wt % to about 20 wt %, for example 5 wt % to 20 wt %, for example, 5 wt % to 15 wt %, based on the total amount of the coating layer. Within the above range, adhesion to the electrode is expressed and battery resistance does not increase, so there may be no limitation in capacity implementation.

The second adhesive layer may have a thickness in a range of about 0.01 μm to about 20 μm, and within the above range, the thickness may be 0.01 μm to 5 μm, 0.1 μm to 3 μm, or 0.1 μm to 1.5 μm.

### Porous Substrate

The porous substrate has a large number of pores and may be or include a substrate typically used in electrochemical devices. The porous substrate may be or include, but is not limited to, a polymer film formed from one polymer such as or including at least one of polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or mixture of two or more thereof.

The porous substrate may be or include, for example, a polyolefin-based substrate including a polyolefin, and the polyolefin-based substrate has a desired or improved shutdown function and thus may contribute to improving the safety of the battery. The polyolefin-based substrate may be or include, for example, at least one of a polyethylene single layer film, a polypropylene single layer film, a polyethylene/polypropylene two-layer film, a polypropylene/polyethylene/polypropylene three-layer film, and a polyethylene/polypropylene/polyethylene three-layer film. In addition, the polyolefin-based resin may include a non-olefin resin in addition to an olefin resin, or may include a copolymer of olefin and non-olefin monomers.

The porous substrate may have a thickness in a range of about 1 μm to about 40 μm, for example, 1 μm to 30 μm, 1 μm to 20 μm, or 5 μm to 15 μm.

The porous substrate may have an air permeability of less than about 200 sec/100 cc, for example, about 190 sec/100 cc or less, or about 180 sec/100 cc or less. In the above range, the porous substrate may be used in the separator.

The separator for a rechargeable battery according to one example embodiment may be formed by applying a composition for forming a coating layer on one side, or on both sides, of a porous substrate, and then drying the composition. The drying may be performed using conventional methods known to those skilled in the art.

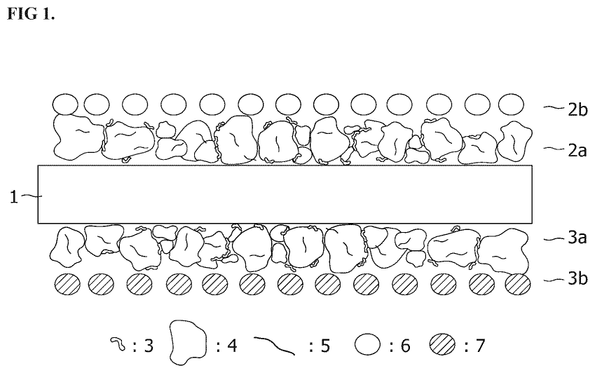

FIG. 1 is a cross-sectional view showing a separator for a rechargeable lithium battery according to one example embodiment.

Referring to FIG. 1, the separator for a rechargeable lithium battery may include a porous substrate 1, a first coating layer 2a and a first adhesive layer 2b located, e.g., sequentially located on a first surface of the porous substrate 1, and a second coating layer 3a and a second adhesive layer 3b located, e.g., sequentially located on a second surface of the porous substrate 1. The first coating layer 2a may include a crosslinked product 3 of a (meth)acrylic binder and an aziridine-based crosslinking agent, a first filler 4, and a second filler 5, and the first adhesive layer 2b may include a (meth)acrylic adhesive binder 6. The second coating layer 3a may include a crosslinked product 3 of a (meth)acrylic binder and an aziridine-based crosslinking agent, a first filler 4, and a second filler 5, and the second adhesive layer 3b may include a fluorine-based adhesive binder 7.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be located between the positive electrode and the negative electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}GgPO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause a chemical change (e.g., does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in the form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause a chemical change (e.g., does not cause an undesirable chemical change in the rechargeable lithium battery), and that conducts electrons, can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber, a conductive polymer such as a polyphenylene derivative, or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolves in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

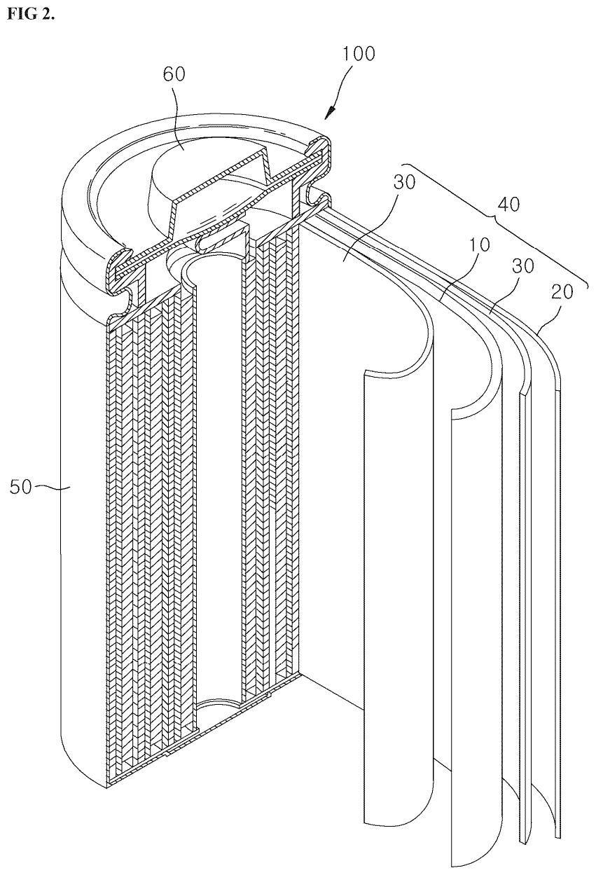

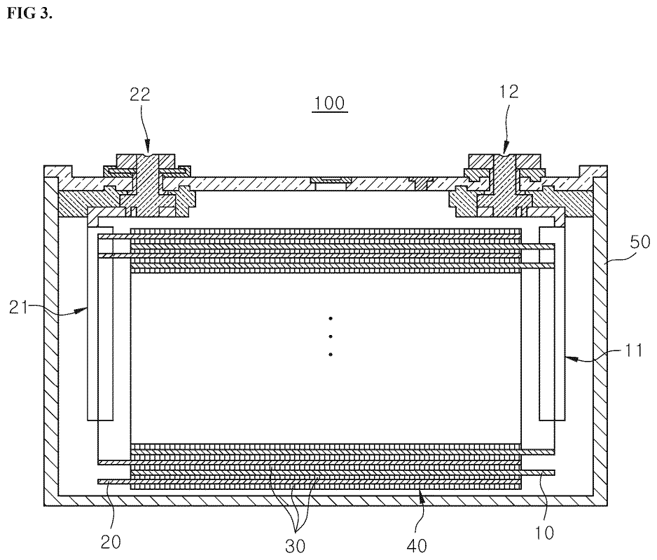

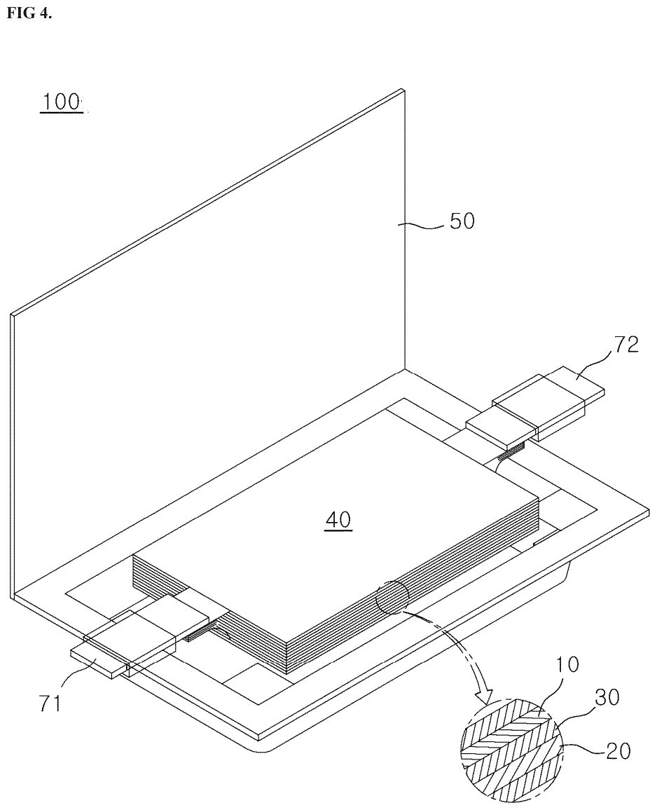

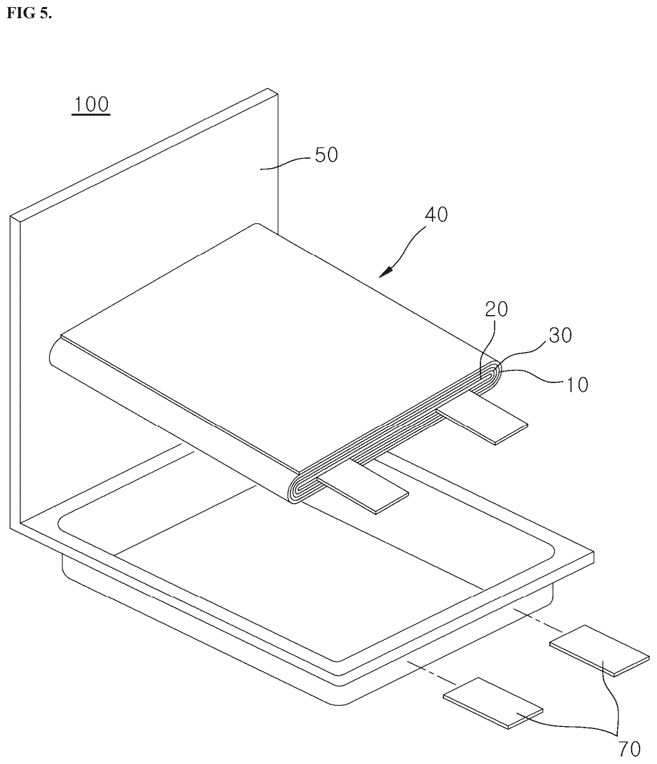

FIG. 2 to FIG. 5 are schematic views illustrating a rechargeable lithium battery according to an example embodiment. FIG. 2 shows a cylindrical battery, FIG. 3 shows a prismatic battery, and FIG. 4 and FIG. 5 show pouch-type batteries. Referring to FIG. 2 to FIG. 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 4 and FIG. 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure are described. However, the following examples are only examples of the present disclosure, and the present disclosure is not limited to the following examples.

### Preparation Example 1

To a 3 L four-necked separable flask equipped with a stirrer, a thermometer, and a condenser, distilled water (1249.72 g), a 20% lithium hydroxide aqueous solution (203.69 g), acrylic acid (AA, 0.30 mol), 2-hydroxyethyl methacrylate (HEMA, 0.10 mol), 2-acrylamido-2-methylpropane sulfonic acid (AMPS, 0.60 mol), and ammonium persulfate (0.001 mol) were added, and then an operation of reducing an internal pressure to 10 mmHg with a diaphragm pump and returning the internal pressure to normal pressure with nitrogen was repeated three times. The reaction was performed for 12 hours while controlling heating so that the temperature of a reaction solution was stabilized between 65° C. and 70° C. After cooling to room temperature, about 10 mL of the reaction solution was taken and a non-volatile (NV) component content was measured, which was 9.8 wt % (theoretical value: 10 wt %). In addition, in the resulting poly(acrylic acid-co-2-hydroxyethyl methacrylate-co-2-acrylamido-2-methylpropane sulfonic acid) lithium salt, a molar ratio of a first structural unit derived from lithium acrylate, a second structural unit derived from 2-hydroxyethyl methacrylate, and a third structural unit derived from lithium 2-acrylamido-2-methylpropane sulfonate was 30:10:60.

### Preparation Example 2

In Preparation Example 1, the content of each monomer was changed to prepare poly(lithium acrylate-co-2-hydroxyethyl methacrylate-co-lithium 2-acrylamido-2-methylpropane sulfonate). A molar ratio of lithium acrylate, 2-hydroxyethyl methacrylate, and lithium 2-acrylamido-2-methylpropane sulfonate is 40:10:50. About 10 mL of a reaction solution (reaction product) was taken and a non-volatile component content was measured, which was 9.0 wt % (theoretical value: 10 wt %).

### Preparation Example 3

In Preparation Example 1, the content of each monomer was changed to prepare poly(lithium acrylate-co-2-hydroxyethyl methacrylate-co-lithium 2-acrylamido-2-methylpropane sulfonate). A molar ratio of lithium acrylate, 2-hydroxyethyl methacrylate, and lithium 2-acrylamido-2-methylpropane sulfonate was 65:5:30. About 10 mL of a reaction solution (reaction product) was taken and a non-volatile component content was measured, which was 9.0 wt % (theoretical value: 10 wt %).

### Preparation Example 4

In Preparation Example 1, the content of each monomer was changed to prepare poly(lithium acrylate-co-2-hydroxyethyl methacrylate-co-lithium 2-acrylamido-2-methylpropane sulfonate). A molar ratio of lithium acrylate, 2-hydroxyethyl methacrylate, and lithium 2-acrylamido-2-methylpropane sulfonate was 40:5:55. About 10 mL of a reaction solution (reaction product) was taken and a non-volatile component content was measured, which was 9.0 wt % (theoretical value: 10 wt %).

### Preparation Example 5

An acrylic copolymer was prepared in the same manner as in Preparation Example 1, except that 2-hydroxyethyl methacrylate and 2-acrylamido-2-methylpropane sulfonic acid were used and acrylic acid was not used. A molar ratio of 2-hydroxyethyl methacrylate and lithium 2-acrylamido-2-methylpropane sulfonate was 74:26. A non-volatile component content of the reaction solution was 9.0 wt % (theoretical value: 10 wt %).

### Preparation Example 6

An acrylic copolymer was prepared in the same manner as in Preparation Example 1, except that acrylic acid and 2-acrylamido-2-methylpropane sulfonic acid were used, and 2-hydroxyethyl methacrylate was not used. A molar ratio of acrylic acid and lithium 2-acrylamido-2-methylpropane sulfonate was 74:26. A non-volatile component content of the reaction solution was 9.0 wt % (theoretical value: 10 wt %).

### Preparation Example 7

An acrylic copolymer was prepared in the same manner as in Preparation Example 1, except that acrylic acid and 2-hydroxyethyl methacrylate were used and 2-acrylamido-2-methylpropane sulfonic acid was not used. A molar ratio of lithium acrylate and 2-hydroxyethyl methacrylate was 42:58. A non-volatile component content of the reaction solution was 9.0 wt % (theoretical value: 10 wt %).

### Example 1

(1) Boehmite (particle size D50: 150 nm, KB-01S of DAEJOO·KC CO., LTD, cubic) as a first filler and nanofibers (boehmite, length: 100 to 500 nm, diameter: 10 to 50 nm) as a second filler were mixed in a weight ratio of 50:50 based on a total of 100 parts by weight to prepare a mixture.

The (meth)acrylic binder (10 wt % in distilled water) prepared in Preparation Example 1 and the mixture prepared above were mixed at a (meth)acrylic binder:filler mass ratio of 1:20, input into a water solvent, then milled and dispersed using a bead mill at 25° C. for 30 minutes to prepare a dispersion.

Trimethylolpropane tris(2-methyl-1-aziridine propionate) (trifunctional aziridine-based crosslinking agent) as an aziridine-based crosslinking agent was input into the dispersion, and water was added so that the total solid content became 20 wt % to prepare a composition for forming a first coating layer and a composition for forming a second coating layer. At this time, the aziridine-based crosslinking agent was included in an amount of 10 parts by weight based on 100 parts by weight of the methacrylic binder.

(2) The composition for forming a first coating layer prepared as described above was applied on a first surface of a polyethylene-based film (thickness: 5.5 μm, CZMZ, air permeability: 110 sec/100 cc, puncture strength: 340 kgf) as a porous substrate using a die coating method, and the composition for a second coating layer prepared as described above was applied on a second surface using a die coating method, and dried and aged in an oven at 70° C. for 16 hours to form a first coating layer and a second coating layer.

(3) A composition including crosslinked polymethyl methacrylate (Tg: 50° C.) was applied on the first coating layer prepared above using a die coating method, and dried and aged to form a first adhesive layer.

(4) A mixture of a fluorine-based homopolymer (having a carbonyl (C═O) functional group) as an aqueous adhesive binder and a binder having an IPN structure of a polyvinylidene fluoride crosslinked polymer and an acrylate crosslinked polymer was diluted to a solid content of 2 wt % to prepare a composition for a second adhesive layer.

(5) The composition for a second adhesive layer prepared as described above was applied on the second coating layer prepared as described above using a die coating method, dried and aged to form a second adhesive layer, thereby manufacturing a separator having a first coating layer (thickness: 0.7 m), a first adhesive layer (thickness: 0.5 m), a second coating layer (thickness: 0.7 m), and a second adhesive layer (thickness: 0.5 m).

### Example 2

A separator was manufactured in the same manner as in Example 1, except that a weight ratio between the fillers was changed to 60:40 in Example 1.

### Examples 3 to 5

Separators were manufactured in the same manner as in Example 1, except that a binder type was changed as shown in Table 1 below and used instead of the binder of Preparation Example 1 in Example 1.

### Comparative Example 1

A separator was manufactured in the same manner as in Example 1, except that the second filler was not used and crosslinked PMMA was used as an adhesive binder in a second adhesive layer in Example 1.

### Comparative Example 2

A separator was manufactured in the same manner as in Example 1, except that a second filler was not used in Example 1.

### Comparative Example 3

A separator was manufactured in the same manner as in Example 1, except that the weight ratio of the fillers in Example 1 was changed and the second adhesive binder was used as the first adhesive binder.

### Comparative Example 4

A separator was manufactured in the same manner as in Example 1, except that polyvinyl alcohol was used as a binder in Example 1.

### Comparative Example 5

A separator was manufactured in the same manner as in Example 1, except that an aziridine-based crosslinking agent was not used in Example 1.

### Comparative Examples 6 to 8

Separators were manufactured in the same manner as in Example 1, except that a binder type was changed as shown in Table 1 below and used instead of the binder of Preparation Example 1 in Example 1.

### Comparative Example 9

A separator was manufactured in the same manner as in Example 1, except that ethylene glycol diglycidyl ether (epoxy-based crosslinking agent) was used instead of the aziridine-based crosslinking agent in Example 1.

### Comparative Example 10

A separator was manufactured in the same manner as in Example 1, except that CARBODILITE V-50 (Nisshinbo Chemical) was used as a carbodiimide (CDI)-based crosslinking agent instead of the aziridine-based crosslinking agent in Example 1.

### Thermal Shrinkage Rate in Electrolyte (Wet Thermal Shrinkage Rate, Units: %)

### Manufacture of Negative Electrode:

97 wt % of graphite particles with an average particle size of 25 μm as a negative electrode active material, 1.5 wt % of a styrene-butadiene rubber (SBR) binder, and 1.5 wt % of carboxymethyl cellulose (CMC) were mixed, and then the mixture was input into distilled water and stirred for 60 minutes using a mechanical stirrer to prepare a negative electrode active material slurry. The slurry was applied onto a 10 m-thick copper current collector using a doctor blade, dried in a hot air dryer at 100° C. for 0.5 hour, dried again under vacuum at 120° C. for 4 hours, and then roll-pressed to manufacture a negative electrode.

### Manufacture of Positive Electrode:

97 wt % of LiCoO₂ as a positive electrode active material, 1.5 wt % of carbon black powders as a conductive material, and 1.5 wt % of polyvinylidene fluoride (PVdF) were mixed, input into an N-methyl-2-pyrrolidone solvent, and stirred for 30 minutes using a mechanical stirrer to prepare a positive electrode active material slurry. The slurry was applied onto a 20 m-thick aluminum current collector using a doctor blade, dried in a hot air dryer at 100° C. for 0.5 hour, dried again under vacuum at 120° C. for 4 hours, and then roll-pressed to manufacture a positive electrode.

One sheet of the sample was placed between the positive electrode and the negative electrode to manufacture three sets of positive electrode-sample-negative electrode laminates, which were then placed in a pouch. 3 g of an electrolyte (1.5 M LiPF₆ dissolved in ethylene carbonate, ethyl methyl carbonate, and dimethyl carbonate (volume ratio of 30:50:20 based on the total volume of 100)) was injected to completely saturate the laminate with the electrolyte, sealed, and allowed to stand at 25° C. for 12 hours. Then, after being left in an oven at 150° C. for 1 hour, the sample was taken out and cooled, and then the dimensions of the sides of the sample were measured to calculate a shrinkage rate. The shrinkage rate may be calculated according to the following Mathematical Formula 1.

$$Shrinkage rate = ( L 0 - L 1 ) / L 0 \times 100.$$

L0 is an initial length of the separator, and L1 is a length of the separator after being left at 150° C. for 1 hour.

### Adhesion to Positive Electrode (Units: Gf/Mm)

The separator was attached to a positive electrode (manufactured in the same manner as in the above battery manufacture) so that the second coating layer of the separator faced the positive electrode, and inserted into a pouch, an electrolyte (1.3 M of LiPF₆ in a 3/5/2 (volume ratio) mixed solvent of ethylene carbonate (EC)/ethyl methyl carbonate (EMC)/diethyl carbonate (DEC)) was injected, and the resulting assembly was left for 12 hours, pressed under conditions of a pressure of 10 to 20 kgf/cm², a temperature of 70 to 90° C., and a time of 5 to 20 seconds, and then disassembled. After taking the separator and positive electrode out of the pouch, the positive electrode and separator were spread out 180°, and the force required to detach the positive electrode from the separator was measured using a tensile tester (Tinius Olsen, HT400).

### Adhesion to Negative Electrode (Units: Gf/Mm)

The separator was attached to a negative electrode (manufactured in the same manner as in the above battery manufacture) so that the first coating layer of the separator faced the negative electrode, and inserted into a pouch, an electrolyte (1.3 M LiPF₆ in a 3/5/2 (volume ratio) mixed solvent of ethylene carbonate (EC)/ethyl methyl carbonate (EMC)/diethyl carbonate (DEC)) was injected, and the resulting assembly was allowed to stand for 12 hours, pressed under conditions of a pressure of 10 kgf/cm² to 20 kgf/cm², a temperature of 70° C. to 90° C., and a time of 5 seconds to 20 seconds, and then disassembled. After taking the separator and negative electrode out of the pouch, the negative electrode and separator were spread out 180°, and the force required to tear the negative electrode from the separator was measured using a tensile tester (Tinius Olsen, HT400).

### Membrane Resistance (Units: Ω)

The membrane resistance was evaluated as electrochemical impedance spectroscopy (EIS) resistance. The separators prepared in the examples and comparative examples were impregnated with an electrolyte (1.5 M LiPF₆ dissolved in a mixed solvent of ethylene carbonate, ethyl methyl carbonate, and dimethyl carbonate (volume ratio of 2/1/7)), fitted onto an aluminum foil electrode with a lead tab, and sealed in an aluminum pack to manufacture test cells, and the resistance (Ω) of the test cell was measured at 20° C. by the AC impedance method (measurement frequency 100 kHz).

TABLE 1

| | | Examples | | | | |
|---|---|---|---|---|---|---|
| | | 1 | 2 | 3 | 4 | 5 |
| Binder | AA | 30 | 30 | 40 | 65 | 40 |
| | HEMA | 10 | 10 | 10 | 5 | 5 |
| | AMPS | 60 | 60 | 50 | 30 | 55 |
| Filler weight ratio | | 50:50 | 60:40 | 50:50 | 50:50 | 50:50 |
| Crosslinking agent | | Aziridine | Aziridine | Aziridine | Aziridine | Aziridine |
| First adhesive layer | | Acryl | Acryl | Acryl | Acryl | Acryl |
| (facing negative | | | | | | |
| electrode) | | | | | | |
| Second adhesive layer | | PVDF | PVDF | PVDF | PVDF | PVDF |
| (facing positive | | | | | | |
| electrode) | | | | | | |
| Wet | MD | 7 | 9 | 5 | 6 | 7 |
| thermal | TD | 7 | 9 | 4 | 6 | 7 |
| shrinkage | | | | | | |
| rate | | | | | | |
| Adhesion | Positive | 1.15 | 1.17 | 1.12 | 1.2 | 1.11 |
| | electrode | | | | | |
| | Negative | 0.74 | 0.73 | 0.7 | 0.78 | 0.72 |
| | electrode | | | | | |

| | | | | | |
|---|---|---|---|---|---|
| Membrane resistance | 0.65 | 0.64 | 0.65 | 0.69 | 0.69 |

TABLE 2

| | | Comparative Examples | | | | |
|---|---|---|---|---|---|---|
| | | 1 | 2 | 3 | 4 | 5 |
| Binder | AA | 30 | 30 | 30 | — | 30 |
| | HEMA | 10 | 10 | 10 | — | 10 |
| | AMPS | 60 | 60 | 60 | — | 60 |
| Filler weight ratio | | 100:0 | 100:0 | 10:90 | 60:40 | 50:50 |
| Crosslinking agent | | Aziridine | Aziridine | Aziridine | Aziridine | 0 |
| First adhesive layer | | Acryl | Acryl | PVDF | Acryl | Acryl |
| (facing negative | | | | | | |
| electrode) | | | | | | |
| Second adhesive layer | | Acryl | PVDF | PVDF | PVDF | PVDF |
| (facing positive | | | | | | |
| electrode) | | | | | | |
| Wet | MD | 59 | 58 | 58 | 57 | 59 |
| thermal | TD | 59 | 59 | 58 | 57 | 58 |
| shrinkage | | | | | | |
| rate | | | | | | |
| Adhesion | Positive | 0.61 | 1.17 | 1.14 | 1.13 | 1.1 |
| | electrode | | | | | |
| | Negative | 0.71 | 0.73 | 0.23 | 0.74 | 0.73 |
| | electrode | | | | | |

| | | | | | |
|---|---|---|---|---|---|
| Membrane resistance | 0.66 | 0.65 | 0.67 | 0.87 | 0.66 |

| | | Comparative Examples | | | | |
|---|---|---|---|---|---|---|
| | | 6 | 7 | 8 | 9 | 10 |
| Binder | AA | 0 | 74 | 42 | 30 | 30 |
| | HEMA | 74 | 0 | 58 | 10 | 10 |
| | AMPS | 26 | 26 | 0 | 60 | 60 |
| Filler weight ratio | | 50:50 | 50:50 | 50:50 | 50:50 | 50:50 |
| Crosslinking agent | | Aziridine | Aziridine | Aziridine | Epoxy | Carbodiimide |
| First adhesive layer | | Acryl | Acryl | Acryl | Acryl | Acryl |
| (facing negative | | | | | | |
| electrode) | | | | | | |
| Second adhesive layer | | PVDF | PVDF | PVDF | PVDF | PVDF |
| (facing positive | | | | | | |
| electrode) | | | | | | |
| Wet | MD | 58 | 57 | 61 | 55 | 56 |
| thermal | TD | 59 | 56 | 62 | 57 | 55 |
| shrinkage | | | | | | |
| rate | | | | | | |
| Adhesion | Positive | 0.61 | 1.09 | 1.12 | 1.11 | 1.1 |
| | electrode | | | | | |
| | Negative | 0.39 | 0.71 | 0.73 | 0.75 | 0.72 |
| | electrode | | | | | |

| | | | | | |
|---|---|---|---|---|---|
| Membrane resistance | 0.75 | 0.86 | 0.69 | 0.69 | 0.67 |

As shown in Table 1 above, the separators for rechargeable lithium batteries of the examples can provide a low thermal shrinkage rate, high rate characteristics during charging and discharging, low membrane resistance, and high adhesion to an electrode plate, thereby increasing battery reliability.

A separator for a rechargeable battery according to one example embodiment can improve the capacity, safety, and lifespan of a battery by providing a low thermal shrinkage rate, high rate characteristics during charging and discharging, low membrane resistance, and high adhesion to an electrode plate.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A separator for a rechargeable battery, the separator comprising:
a porous substrate;
a first coating layer and a first adhesive layer located on a first surface of the porous substrate; and
a second coating layer and a second adhesive layer located on a second surface of the porous substrate,
wherein the first coating layer and the second coating layer each include a crosslinked product of a binder and a crosslinking agent, and a filler, the binder includes a (meth)acrylic binder including a first structural unit derived from (meth)acrylic acid, (meth)acrylate, or a salt thereof, a second structural unit derived from hydroxyalkyl (meth)acrylate, and a third structural unit derived from (meth)acrylamidosulfonic acid or a salt thereof, and the crosslinking agent includes an aziridine-based crosslinking agent,
the filler includes a mixture of a first filler and a second filler, wherein the first filler is an inorganic filler and the second filler is a fibrous filler,
the first adhesive layer includes a (meth)acrylic adhesive binder, and
the second adhesive layer includes a fluorine-based adhesive binder having a carbonyl group (C═O).

2. The separator of claim 1, wherein the (meth)acrylic binder comprises a salt-based binder.

3. The separator of claim 1, wherein the first filler and the second filler are included in a weight ratio in a range of about 50:50 to about 95:5 based on 100 parts by weight of the mixture.

4. The separator of claim 1, wherein the first filler has an average particle size D50 in a range of about of 100 nm to about 200 nm.

5. The separator of claim 1, wherein the second filler has an aspect ratio of about 5 or more.

6. The separator of claim 1, wherein the second filler fills space between the first fillers.

7. The separator of claim 1, wherein the (meth)acrylic binder and the mixture are included in a mass ratio in a range of about 1:10 to about 1:40.

8. The separator of claim 1, wherein the aziridine-based crosslinking agent comprises at least one or more of N,N′-toluene-2,4-bis(1-aziridine carboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

9. The separator of claim 1, wherein the crosslinking agent is included in an amount in a range of about 5 parts by weight to about 50 parts by weight based on 100 parts by weight of the (meth)acrylic binder.

10. The separator of claim 1, wherein the first structural unit is represented by at least one of Chemical Formula 1, Chemical Formula 2, Chemical Formula 3, and a combination thereof: 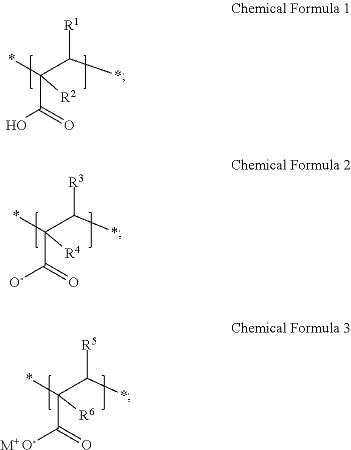
the second structural unit is represented by Chemical Formula 4: 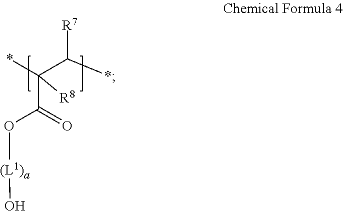
and
the third structural unit is represented by at least one of Chemical Formula 5, Chemical Formula 6, Chemical Formula 7, and a combination thereof: 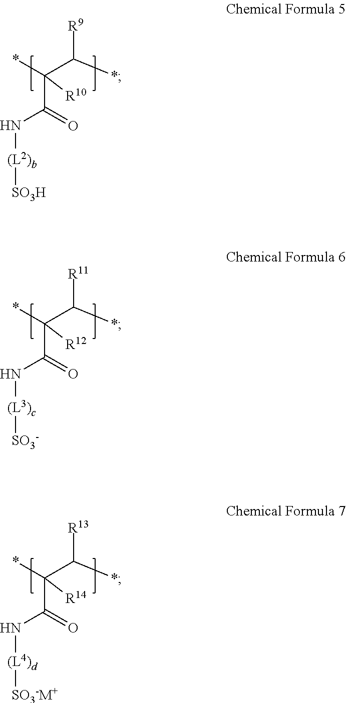
wherein R¹ to R¹⁴ each independently comprises hydrogen or a C1 to C10 alkyl group,
L¹ to L⁴ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, and d are each independently an integer in a range from 0 to 2, and
M comprises an alkali metal.

11. The separator of claim 1, wherein the (meth)acrylic binder is represented by Chemical Formula 8: 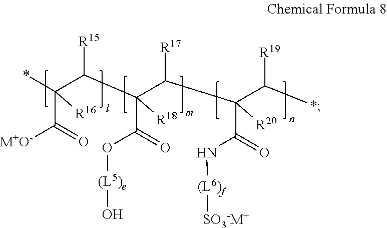
wherein:
R¹⁵ to R²⁰ each independently comprises hydrogen or a C1 to C10 alkyl group,
L⁵ and L⁶ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
M comprises an alkali metal,
e and f are each independently an integer in a range from 0 to 2 and
l, m, and n are molar ratios of each unit, and l+m+n=1.

12. The separator of claim 1, wherein:
the first structural unit is included in an amount in a range of about 20 mol % to about 75 mol %;
the second structural unit is included in an amount in a range of about 1 mol % to about 20 mol %; and
the third structural unit is included in an amount in a range of about 20 mol % to about 75 mol %, based on 100 mol % of the (meth)acrylic binder.

13. The separator of claim 1, wherein a sum of the contents of the first structural unit, the second structural unit, and the third structural unit is about 95 mol % or more based on 100 mol % of the (meth)acrylic binder.

14. The separator of claim 1, wherein the (meth)acrylic adhesive binder has a glass transition temperature in a range of about 50° C. to about 110° C.

15. The separator of claim 1, wherein the fluorine-based adhesive binder comprises a fluorine-based homopolymer having a carbonyl functional group and an IPN structure of a polyvinylidene fluoride crosslinked polymer and an acrylate crosslinked polymer.

16. A rechargeable battery comprising:
a positive electrode;
a negative electrode; and
the separator for a rechargeable battery of claim 1 between the positive electrode and the negative electrode.
